(19) United States
(12) Patent Application Publication
(10) Pub. No.: US 2006/0201059 A1
(43) Pub. Date: Sep. 14, 2006

(54) Method of manufacturing a water-permeable, root blocking, gardening and construction apparatus

(76) Inventor: George Patrick Solis, Houston, TX (US)

Correspondence Address: GEORGE PATRICK SOLIS, 12463 Barryknoll Lane, Houston, TX, 77024, US

(21) Appl. No.: 11/074,895

(22) Filed: Mar. 8, 2005

(51) Int. Cl. A01G 13/02

(52) U.S. Cl. 47/32.7

(57) ABSTRACT

A method of manufacturing a gardening and construction apparatus is provided. The method includes a step of positioning a liquid permeable barrier between a first reinforcing member and a second reinforcing member. The second reinforcing member is wider than the first reinforcing member and includes an extension region that extends beyond the first reinforcement member. Another step of the method includes maintaining relative positions of the first and second reinforcement members by folding the extension region around the first reinforcement member.

### CROSS-REFERENCE TO RELATED APPLICATIONS

This application incorporates by reference the following commonly owned U.S. Patents:

| U.S. Pat. No. | Title | Issue Date |
|---|---|---|
| 6,108,972 | Apparatus for and Methods of | Aug. 29, 2000 |
| | Bracing Soil, Retaining Water, | |
| | and Blocking Roots | |
| 6,189,263 | Method of Building a Garden Bed | Feb. 20, 2001 |
| 6,230,439 | Method of Blocking Root Travel | May 15, 2001 |
| | From a First Subterranean Area | |
| | to a Second Subterranean Area | |
| 6,270,286 | Soil Brace and Root Blocker | Aug. 7, 2001 |

### BACKGROUND OF THE INVENTION

1. Field of the Invention

The present invention relates generally to a gardening and construction apparatus and more specifically to a method for manufacturing a gardening and construction apparatus that blocks roots but is water permeable.

2. Description of Related Art

Ornamental gardening, as opposed to produce gardening, around a residence has been a popular activity for hundreds of years. Traditional English gardening has its roots in the aristocratic gardens of royal home owners and slowly became practiced on a smaller scale around typical residences.

Perusal of the volume of gardening books and magazines in any bookstore reveals that gardening is indeed very popular in the United States.

Many garden purists believe that a garden is not complete without water. However, providing water in a garden, whether as a pond or running stream, is a complicated task which presents many problems.

Other inherent gardening problems include maintaining plants and/or their roots in a desired section of the garden, and bracing soil around the edges of beds.

There are many prior art patents and articles directed to providing water in a garden, maintaining plants and/or their roots in a desired section of the garden, or bracing soil around the edges of beds, but few are as effective as the gardening and construction apparatus disclosed in U.S. Pat. Nos. 6,108,972; 6,189,263, 6,230,439; and 6,270,286, all of which are commonly owned by the applicant of the present invention.

Conventional soil bracing products that are commercially available to the recreational gardener are generally made out of either solid metal or plastic. For example, LineUps™ earth retainer beams are available from Serenity Ponds & Streams of Seal Beach, California, and the 1997 Gardener's Supply Company of Burlington, Vermont offers recycled plastic retainer beams with preformed corner fasteners.

However, many of these commonly available braces suffer from several deficiencies. These commercially available solid braces do not allow water to easily escape out of the bed, resulting in unhealthy plants, bogging soil, and plant root rot. In some instances the added weight of the retained water can threaten the soil brace. It is also noted that conventional soil bracing products are typically available in four to six inch widths that do not offer elevated bed support. It is even also noted that conventional products such as steel edging or thick plastic edging can be heavy, very hard or impossible to bend, and very difficult to adapt to a particular geometric arrangement as needed. It is still also noted that many of the conventional bracing products such as steel edging require special expensive metal cutters for onsite fabrication. It is yet also noted that conventionally available steel edging is generally heavy and expensive to ship.

Thus, in spite of the advancements in the prior art, there is still a number of deficiencies in the prior art requiring a need for improvement in methods of and apparatus for providing water in a garden, maintaining plants and/or their roots in a desired section of the garden, and bracing soil around the edges of beds.

There is another need in the art for a garden landscaping soil brace and/or water retaining brace which is long lasting, strong and durable.

There is even another need in the art for a garden landscaping and/or water retaining brace which allows the flow of water, nutrients and fertilizers in both directions across the brace.

There is still another need in the art for a garden landscape brace and/or water retaining brace which can easily be adaptable to various widths and lengths for adaptation to various landscape needs.

There is yet another need in the art for a garden landscape brace and/or water retaining brace which is flexible to allow the landscaper to adapt the brace to curves as well as straight lines without any special fittings that are required by some conventional products.

There is even still another need in the art for a garden landscape brace and/or water retaining brace which is easy to cut and install resulting in decreased installation time, and which does not require special expensive metal cutters.

There is even yet another need in the art for a garden landscape brace and/or water retaining brace which is of lighter weight, resulting in reduced shipping charges and lower costs to the ultimate purchaser.

There is still even another need in the art for a garden landscape brace and/or water retaining brace which is less costly than the current all metal braces.

There is still yet another need in the art for a garden landscape brace and/or water retaining brace which is not too obtrusive or noticeable when utilized in a garden to provide more of a natural garden appearance.

Finally, there is a need for a garden landscape brace or gardening and construction apparatus that can be easily and inexpensively manufactured.

These and other needs in the art will become apparent to those of skill in the art upon review of this specification, including its drawings and claims.

### BRIEF SUMMARY OF THE INVENTION

The problems presented in manufacturing gardening braces are solved by the systems and methods of the present invention. A method of manufacturing a gardening and construction apparatus includes a step of positioning a liquid permeable barrier between a first reinforcement member and a second reinforcement member. The second reinforcement member is wider than the first reinforcement member, which creates at least one extension region that extends beyond an edge of the first reinforcement member. In another step of the method, the relative positions of the first and second reinforcement members are maintained by folding the at least one extension region of the second reinforcement member around a portion of the first reinforcement member.

A gardening and construction apparatus is also provided in accordance with the present invention. The gardening and construction apparatus includes a first reinforcement member having a first edge and a second edge. A second reinforcement member is also provided. The second reinforcement member includes a central support portion and a pair of wings, the wings being disposed on opposing longitudinal sides of the central support portion. The wings are folded around the first and second edges of the first reinforcement member to secure the second reinforcement member to the first reinforcement member. A liquid permeable barrier is further provided and is disposed between the first reinforcement member and the second reinforcement member.

Other objects, features, and advantages of the present invention will become apparent with reference to the drawings and detailed description that follow.

### BRIEF DESCRIPTION OF THE DRAWINGS

FIG. 1 is an illustration of soil brace 100 of the present invention, including barrier 110 and reinforcement member 104;

FIG. 2 is a side view of soil brace 100 of FIG. 1, showing barrier 110 and reinforcement member 104;

FIG. 3 is a side view of pond 300 consisting of pond excavation 301 of any desired shape having a pond edge or perimeter 302, soil brace 100 of the present invention, and pond retaining wall 305;

FIG. 4 illustrates a perspective view of a method of manufacturing a gardening and construction apparatus according to the principles of the present invention;

FIG. 5 depicts a perspective view of a method of manufacturing a gardening and construction apparatus according to the principles of the present invention;

FIG. 6 illustrates a detailed perspective view of a first reinforcement member, a second reinforcement member, and a water permeable barrier prior to undergoing the manufacturing processes of either FIG. 4 or FIG. 5;

FIG. 7 depicts a cross-sectional front view of one step in the manufacturing process of FIG. 5;

FIG. 8 illustrates a cross-sectional front view of another step in the manufacturing process of FIG. 5;

FIG. 9 depicts a cross-sectional front view of still another step in the manufacturing process of FIG. 5; and

FIG. 10 illustrates a flow chart of steps in a method of manufacturing a gardening and construction apparatus according to the principles of the present invention.

### DETAILED DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical structural, mechanical, electrical, chemical and material changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

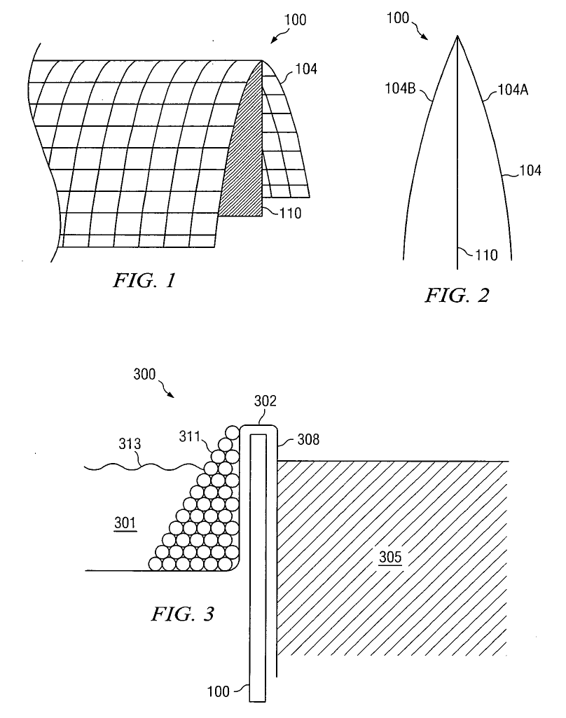

Referring now to FIGS. 1 and 2 there is shown an illustration of and side view of, respectfully, soil brace 100 of the present invention. In the embodiment as shown in FIGS. 1 and 2, soil brace 100 includes barrier 110 and reinforcement member 104.

In the practice of the present invention, it should be understood that barrier 110 may be of any physical structure suitable for the intended garden or water application of soil brace 100. For example, it is generally desired that barrier 110 be suitable for preventing penetration by roots and/or vegetation, while still allowing water, nutrients, and fertilizers to pass through the barrier 110. Such a structure is preferably woven or non-woven.

In the practice of the present invention, any material may be utilized as the material for barrier 110 provided that the selected material is suitable to withstand long term contact with the soil, and if it is to be utilized in an agricultural, garden, or construction setting, that such barrier 110 be suitable to withstand exposure to the various chemicals that are utilized in agricultural or garden settings such as herbicides, insecticides, fertilizers, plant foods, and the like.

It should be understood that while barrier 110 may be comprised of a material that is inherently resistant to exposure to such soil and the various chemicals, lesser materials may be utilized if such are provided with a suitable coating or protective layer suitable to protect against exposure to such soil and chemicals.

While any material meeting the requirements as specified above may be utilized as barrier 110, it is preferred in the practice of the present invention that barrier 110 be constructed from a polymeric material. Non limiting examples of polymeric materials which are suitable for forming a woven barrier 110 of the present invention include polyester, polyamid, polypropylene, polyethylene, nylon, rayon, and polyamids.

In some instances, it may be desired to provide a barrier with certain selected chemicals, for example, herbicides, insecticides, fertilizers, plant foods, and the like, which diffuse into the soil over time. The barrier may also be provided with a water insoluble inorganic copper compound in an amount effective to stop root growth as disclosed in U.S. Pat. No. 5,575,112, issued Nov. 19, 1996 to Scheubel, herein incorporated by reference. Alternatively, the barrier may be provided with impregnated root growth inhibitors in an amount to stop root growth.

The reinforcement member 104 of the present invention, may be made of any suitable material that will provide the necessary reinforcement to barrier 110. Of course, the amount of reinforcement necessary will depend upon the inherent properties of barrier 110, and the application to which soil brace 100 is being applied.

As with barrier 110, reinforcement member 104 should comprise a material suitable to withstand long term exposure to soils and resist rotting, rusting and/or degradation. Where soil brace 100 is to be utilized in agricultural, garden, or construction settings, it should also be adequately resistant to exposure to chemicals which are normally found in such agricultural, garden, and construction settings, such as fertilizers, herbicides, insecticides, plant foods, and the like.

Reinforcement member 104 may be formed from a suitable metal, polymeric material, treated wood, composite material, or ceramic as desired. Preferably, reinforcement member 104 comprises metal or polymeric material. More preferably, the reinforcement member 104 comprises a galvanized wire with or without a vinyl covering, or a durable plastic.

In the embodiment of brace 100 as shown in FIGS. 1 and 2, reinforcement member 104 comprises a first grid member 104A and a second grid member 104B between which is sandwiched barrier 110. It should be noted that reinforcement member 104 may comprise to join together first grid member 104A and second grid member 104B as shown in FIG. 1, or it may comprise two disjointed members first grid member 104A and second grid member 104B. The grid size of reinforcement member 104 is generally selected to provide a uniform reinforcement with grid openings in the range of about 1/16 inches to about 2 inches, preferably in the range of about ⅛ inches to about 1 inches, and even more preferably in the range of about ¼ inches to about ½ inches.

While the embodiment of brace 100 as shown includes a reinforcement member having a grid of uniform rectangular shape, there is no requirement that the grid be so limited, as any other suitable grid shape may be utilized.

It should also be noted that while the embodiment of brace 100 is shown as having a first grid member 104A and a second grid member 104B between which is sandwiched barrier 110, it should be understood that any number of grid members and barriers may be utilized, with any desired arrangement of grid members and barriers utilized. As non-limiting examples, one or more barriers in the interior may be sandwiched between one or more grid members on the outside, or barrier layers may be interspersed between any number of grid members.

Barrier 110 and reinforcement member 104 are assembled by any suitable technique to form soil brace 100. The most simple assembly technique would include sandwiching barrier 110 between reinforcement member 104 and suitably interlocking the edges of one-half of reinforcement member 104 with the other half of reinforcement member 104, for example by twisting or otherwise interlocking the edges together. Another suitable technique would include sandwiching barrier 110 between reinforcement members 104A and 104B, and affixing barrier 110 to reinforcement member 104, for example through the use of stitching, fusing, threading, anchoring, gluing, or adhering.

Soil brace 100 of the present invention is believed to be long lasting, strong, and durable. The more preferred embodiment of soil brace 100 comprises either a galvanized wire mesh with or without a vinyl covering, or a durable plastic mesh that will resist rotting, rusting or other degradation.

As barrier 110 and reinforcement member 104 allow for flow of water there through, soil brace 100 will allow the flow of water, nutrients and fertilizers into and out of any garden beds made therefrom. Therefore, the added weight of water in the garden bed will not cause undue pressure against soil brace 100 used to make such bed, and as water can escape out of the bed there is better soil drainage producing healthier plants and less root suffocation, and/or rot.

Soil brace 100 may be made to any suitable standard commercial length, thickness and width depending upon the desires of the application by appropriate selection of the length, thickness and width of the barrier and reinforcement members. The materials of construction for both reinforcement member 104 and barrier 110 are also generally selected so that soil brace 100 may be easily cut by the end use gardener utilizing conventional tools without the need to utilize special expensive metal cutters. The materials of construction are also selected to allow for easy cutting to decrease installation time. The materials of construction for soil brace 100 are also preferably selected to provide a soil brace 100 which is flexible and bendable, thereby allowing the end-use landscaper to adapt the soil brace 100 to curvilinear as well as straight lines without requiring any special fittings such as those required by some conventional products.

According to the present invention, the construction materials for soil brace 100 are also preferably selected to provide a soil brace 100 which is generally lightweight to provide for ease of handling during installation, and to provide for reductions in shipping costs. Preferably, the materials of construction for soil brace 100 and its method of assembly are selected to provide a product that is relatively affordable to the end-use landscaper.

The colors of the soil brace 100 are generally selected to provide for a soil brace which is generally not obtrusive or noticeable, thereby producing a natural garden appearance. Non-limiting examples of suitable colors include most shades of green, brown, and black. Preferably, soil brace 100 is substantially the color of the soil which it is bracing.

Soil brace 100 finds utility in a wide variety of applications.

Support Soil

One envisioned application of soil brace 100 is to support soil, as for example, at the edge of a garden bed or to support soil at the edge of a liner pond or stream, by vertical placement of soil brace 100 next to the soil being supported.

Where additional support is needed for soil brace 100, support stakes, as a non-limiting example, 2×2 wooden stakes, may be placed at appropriate intervals on one or both sides of soil brace 100. Similarly, anchor stakes could be used to assist in anchoring the soil brace 100. However, soil brace 100 can be installed without using support stakes or anchor stakes.

For elevated beds, the ability of water to freely flow through soil brace 100, as opposed to conventional solid-type landscape edging, means that there is not the added weight of water in the bed to weigh against the brace, as would occur with the conventional edging. Use of soil brace 100 will provide an environment for healthier plants with better drainage resulting in less root rot and suffocation.

The flexibility of soil brace 100 allows for the construction of a wide variety of regular and irregular geometric and other complicated shapes of ponds, streams and garden beds.

A garden bed may be constructed by simply anchoring one edge of soil brace 100 a suitable distance in the ground in the desired bed shape and then filling the created shape with the desired type of soil or garden mix. By eliminating the need to excavate the entire volume of the bed, bed building is easier, less laborious, less expensive, and provides good drainage for a healthier plant environment.

Soil brace 100 should allow for the construction of narrow, elevated garden beds in areas where there ordinarily would not be enough space.

It is believed that soil brace 100 would provide for containment of soil within the configured garden bed to reduce spillage of soil and mulch onto driveways, walkways, pathways, patios, or onto grass, particularly after heavy rains. The garden thus remains neater, tidier, and cleaner.

Pond Construction

One embodiment of the pond construction method will now be described by reference to FIG. 3.

There is shown in FIG. 3 a pond 300 consisting of a pond excavation 301 of any desired shape having a pond edge or perimeter 302, soil brace 100 of the present invention, and a pond retaining wall 305.

In the method of the present invention, pond excavation 301 is first excavated to the desired depth profile and shape. Next, around perimeter 302 of pond excavation 301, soil brace 100 is vertically positioned and anchored in the soil as shown. In most instances, the top edge of soil brace 100 is positioned in the range of about 2 to about 3 inches above the water and soil level. The anchoring is generally accomplished by positioning part of soil brace 100 into the soil, although such bracing can also be reinforced by cement in the soil and/or other mechanical reinforcement. For example, 2×2 wooden stakes may be positioned on either or both sides of soil brace 100. The top portion of soil brace 100 is generally allowed to extend above the water or soil level a few inches as desired or even flush with the water or soil level.

Once soil brace 100 is positioned around perimeter 302, pond liner 308 is then positioned in pond excavation 301 and over soil brace 100 as shown in FIG. 3. Soil brace 100 may be provided with an exterior that is rough to both help anchor soil brace 100 in the ground, and to help anchor pond liner 308 against soil brace 100. Such roughness may be provided by an irregular surface having a desired surface roughness, or by projections on the surface.

Dirt 305 is then provided to bury both soil brace 100 and pond liner 308 as shown. A multiplicity of rocks, stones or other material 311 may optionally be provided to give the edge of pond 300 a more realistic look.

The perimeter 302 where pond liner 308 is exposed may be unfinished, or may be finished by covering with plants, decorative stone, or paving.

Pond liners are well known in the art, and any suitable type of pond liner may be used. Polyethylene has been used as a pond liner material since the 1940s, but its disadvantages are that it is easily punctured, can stretch very thin, and is a difficult material to join. However, if polyethylene is utilized, a gauge in the range of about 1,000 to about 1,500 is suggested. While polyvinyl chloride liners are more expensive than standard polyethylene liners, they are much stronger. Such PVC liners have semi-elasticity and are more resistant to ultra violet damage. Suitable thicknesses for PVC are generally in the range of about 0.5 to about 0.75 mm. Twin laminate PVC reinforced with mesh is also available for use as a pond liner. The most preferred material for use as a pond liner is a butyl liner made from a synthetic material (isobutylene and isoprene). Butyl liners have excellent flexibility and elasticity and a very long life span.

Root Blocking

Another envisioned application of soil brace 100 is vertical placement of soil brace 100 to restrict the horizontal growth or spread of weeds, plants and/or their roots. Such root blocking may be either to keep certain plants in or to keep out certain plants.

For example, soil brace 100 may be placed around selected plants to keep them within or outside of a certain area. For example, soil brace 100 has been utilized to keep the highly invasive canna lily within a garden bed, to keep Liriope from advancing into a garden bed, and around rose beds to block surrounding tree roots from growing into the rose bed and robbing the soil of nutrients.

As another example, soil brace 100 has been used to dwarf a tree by placing it around the tree to restrict the reach of its roots and therefore of its canape (and thus its size).

It is also believed that soil brace 100 may be utilized with seedlings in nurseries. For example, to surround seedling plants to prevent intermingling of the roots, or as shown in U.S. Pat. No. 5,393,313, herein incorporated by reference.

Alternatively, soil brace 100 may be utilized to prevent other plant roots from coming into certain areas, as for example, blocking tree roots from entering a rose garden, or perhaps keeping roots away from plumbing or drainage pipes, sidewalks, or a structural foundation.

Other Uses

Other uses for soil brace 100 include landscape edging, root block foundation edging, and soil erosion control edging (also referred to as a “silt fence”).

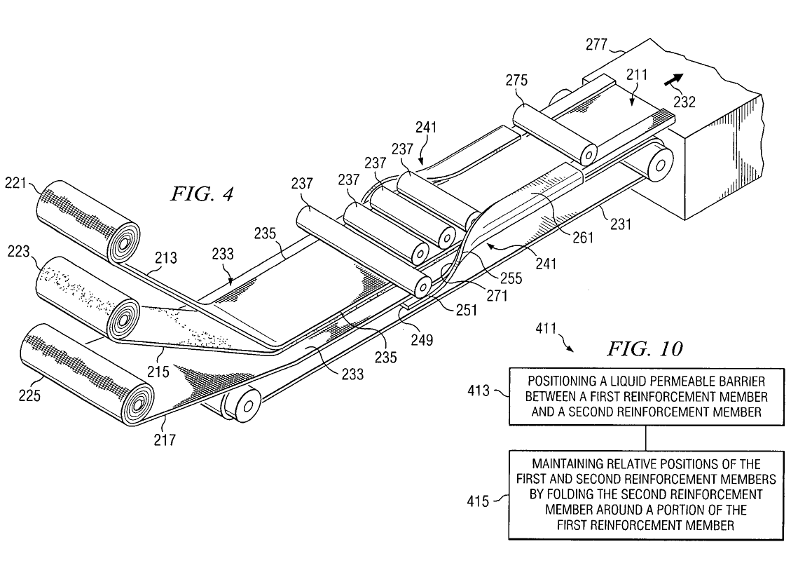

Referring to FIG. 4, a method of manufacturing a gardening and construction apparatus, or soil brace 211 according to the principles of the present invention is illustrated. Soil brace 211 is preferably assembled from three separate components: a first reinforcement member 213, a liquid permeable barrier 215, and a second reinforcement member 217. The first reinforcement member 213, liquid permeable barrier 215, and second reinforcement member 217 are preferably provided in continuous rolls 221, 223, and 225, respectively to further simplify and speed the manufacturing process. However, a person having ordinary skill in the art of the present invention will recognize that individual, pre-cut sheets of material could be used in place of the continuous rolls 221, 223, and 225.

The first reinforcement member 213, liquid permeable barrier 215, and second reinforcement member 217 move along a conveyor system 231 in a direction of production indicated by arrow 232. Preferably, the second reinforcement member 217 is wider than both the first reinforcement member 213 and the liquid permeable barrier 215 and provides a base upon which the first reinforcement member 213 and the liquid permeable barrier 215 are centered. The liquid permeable barrier 215 is preferably approximately the same width as the first reinforcement member 213, but the liquid permeable barrier 215 could be narrower or wider than the first reinforcement member 213. The centering of the first reinforcement member 213 and the liquid permeable barrier 215 on the second reinforcement member 217 creates an extension region 233 on each side of the second reinforcement member 217 that extends beyond each longitudinal edge 235 of the first reinforcement member 213. While it is preferable to center the first reinforcement member 213 and the liquid permeable barrier 215 on the second reinforcement member 217, thereby creating extension regions 233 of equal width as shown in FIG. 4, it should be recognized that it is also possible to arrange the first reinforcement member 213 and the liquid permeable barrier 215 such that extension regions 233 of unequal widths are created.

A plurality of rollers 237 are provided to assist in moving the first reinforcement member 213, liquid permeable barrier 215, and second reinforcement member 217 along the conveyor system 231. The rollers 237 also exert some downward force to the first reinforcement member 213, liquid permeable barrier 215, and second reinforcement member 217 to keep the three components in close relation to one another and firmly on the conveyor system 231.

A tunnel 241 is provided along each side of the conveyor system 231 to fold each extension region 233 of the second reinforcement member 217 around the first reinforcement member 213 and the liquid permeable barrier 215. Tunnel 241 is constructed from a relatively stiff material such as metal or structural plastic such that the tunnel 241 will not excessively deflect when contacted by the second reinforcement member 217. The tunnel 241 works as a folding tool to fold or bend the second reinforcement member 217. As the second reinforcement member 217 approaches the tunnel 241, the extension region 233 on that side of the second reinforcement member 217 engages the tunnel 241, and the shape of the tunnel 241 causes a deflection of the second reinforcement member 217 that results in a fold as the second reinforcement member 217 moves in the direction of production 232.

The tunnel 241 is formed by a wall 249 and includes an entry region 251, a turning region 255, and a crimping region 261. The wall 249 at the entry region 251 is relatively flat and disposed underneath the extension region 233 of the second reinforcement member 217. The entry region 251 is wide enough that it preferably extends just outside of the extension region 233. The entry region 251 transitions into the turning region 255 in which the wall 249 includes an arcuate bend that tapers inward toward the center of the conveyor system. The arcuate, inwardly-tapering bend in wall 249 folds the wall 249 over the conveyor system 231 such that the wall is positioned above the conveyor system 231 in the crimping region 261. Because the turning region 255 tapers inward, the crimping region 261 is positioned more closely than the entry region 251 to the conveyor system 231, the first reinforcement member 213, and the liquid permeable barrier 215.

The various regions of the tunnel 241 serve to fold the second reinforcement member 217 around portions of the first reinforcement member 213 and the liquid permeable barrier 215. As the second reinforcement member 217, the first reinforcement member 213, and the liquid permeable barrier 215 approach the tunnel 241, the second reinforcement member 217 enters the tunnel 241 by passing over the top of the entry region 251. As the second reinforcement member 217 enters the turning region 255 of the tunnel 241, the extension region 233 of the second reinforcement member 217 engages wall 249 and is forced to bend upward away from the conveyor system 231. The upward movement of the extension region 233 is caused by an initiation force and creates a wing 271. The initiation force results from the relatively static disposition of the tunnel 241, which interferes with the forward motion of the second reinforcement member 217, thereby forcing the extension region 233 in an upward direction. The formation of the wing 271 is limited to the area of the extension region 233 by placing rollers 237 above the second reinforcement member 217 adjacent to the turning region 255 of the tunnel 241. The rollers 237 hold the first reinforcement member 213, the liquid permeable barrier 215, and that portion of the second reinforcement member 217 between the extension regions 233 against the conveyor system 231 as the wing 271 is formed in the turning region 255 of the tunnel 241. As the second reinforcement member 217 moves further into the turning region 255, the inwardly-tapering aspect of the tunnel 241 exerts an inward force on the wing 271 that pushes the wing 271 inward toward the center of the conveyor system 231. Further advancement through the turning region 255 and into the crimping region 261 exerts a crimping force on the wing 271 that is directed downward toward the conveyor system 231. The crimping force directs the wing 271 into a position that is adjacent to a portion of the first reinforcement member 213 and substantially parallel to that portion of the second reinforcement member 213 that was between the extension regions 233. In addition to or in lieu of the crimping force provided by the crimping region 261, the crimping force may also be provided by a crimping roller 275 positioned downstream of the tunnel 241.

After exiting the tunnel 241 and passing under the optional crimping roller 275, the first reinforcement member 213, the liquid permeable barrier 215, and the second reinforcement member 217 are interlocked such that the second reinforcement member 217 cradles the first reinforcement member 213 and the liquid permeable barrier 215. The wings 271 of the second reinforcement member 217 have been folded around the edges of the first reinforcement member 213 to securely retain the three components of the soil brace 211 together. Although illustrated in relation to another assembly process for the soil brace, FIG. 9 depicts a soil brace similar to soil brace 211 following assembly. Referring again to FIG. 4, the assembled soil brace 211 is preferably advanced to either another portion of the conveyor system 231 or to a table 277 where a cutting operation is performed to obtain discrete, desired lengths of the soil brace 211. The cutting operation 211 can be accomplished by any tools used to cut through the components of the soil brace 211.

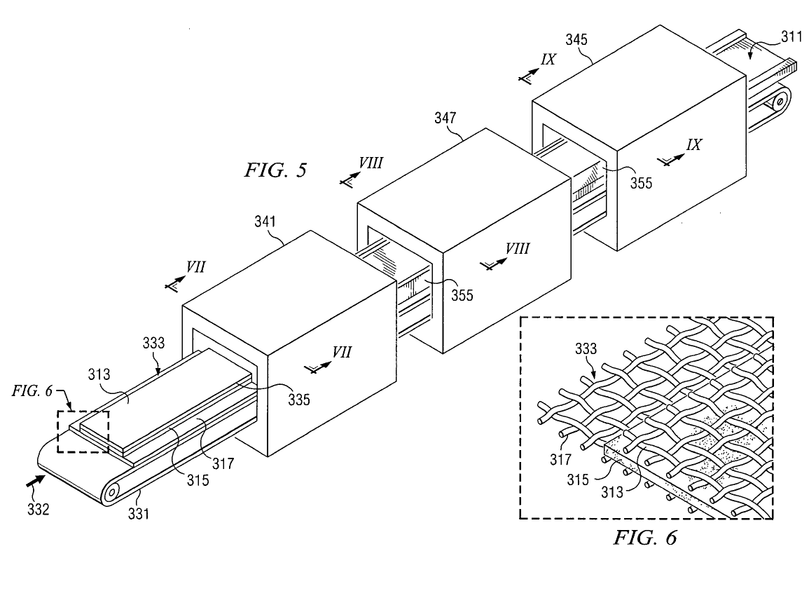

Referring to FIGS. 5-9, a method of manufacturing a gardening and construction apparatus, or soil brace 311 according to the principles of the present invention is illustrated. Soil brace 311 is preferably assembled from three separate components: a first reinforcement member 313, a liquid permeable barrier 315, and a second reinforcement member 317. The first reinforcement member 313, liquid permeable barrier 315, and second reinforcement member 317 could be provided in continuous rolls such as those shown in FIG. 4, but it is preferable to provide the components of the soil brace in discrete, pre-cut lengths for easier processing and assembly.

The first reinforcement member 313, liquid permeable barrier 315, and second reinforcement member 317 move along a conveyor system 331 in a direction of production 332. Preferably, the second reinforcement member 317 is wider than both the first reinforcement member 313 and the liquid permeable barrier 315 and provides a base upon which the first reinforcement member 313 and the liquid permeable barrier 315 are centered. The centering of the first reinforcement member 313 and the liquid permeable barrier 315 on the second reinforcement member 317 create an extension region 333 on each side of the second reinforcement member 317 that extends beyond each longitudinal edge 335 of the first reinforcement member 313. While it is preferable to center the first reinforcement member 313 and the liquid permeable barrier 315 on the second reinforcement member 317, thereby creating extension regions 333 of substantially equal width as shown in FIG. 5, it should be recognized that it is also possible to arrange the first reinforcement member 313 and the liquid permeable barrier 315 such that extension regions 333 of unequal widths are created.

A plurality of rollers (not shown) may be provided to assist the movement of the first reinforcement member 313, liquid permeable barrier 315, and second reinforcement member 317 along the conveyor system 331. The rollers may also exert a downward force to the first reinforcement member 313, liquid permeable barrier 315, and second reinforcement member 317 to keep the three components in close relation to one another and firmly on the conveyor system 331.

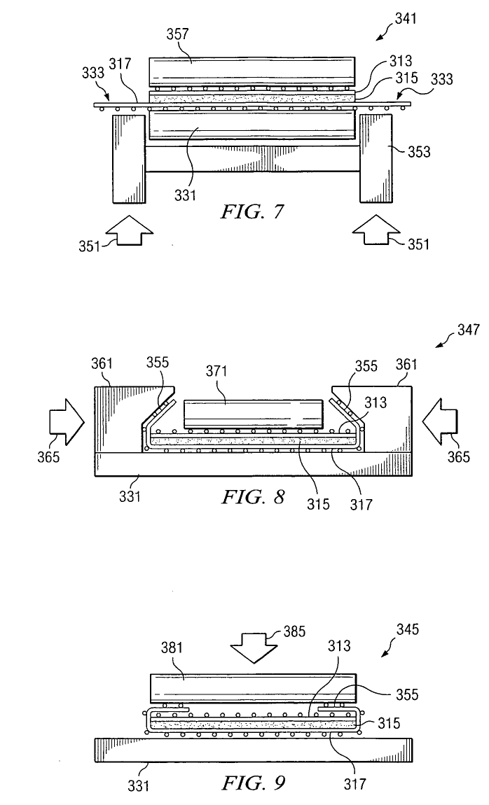

The manufacturing method of FIG. 5 preferably may be divided into at least two different phases: an initiation phase 341 and a crimping phase 345. An optional intermediate phase 347 can be performed between the initiation phase 341 and the crimping phase 345. The initiation phase 341, the intermediate phase 347, and the crimping phase 345 are illustrated in more detail in FIGS. 7-9, respectively.

Referring to FIG. 6, a detailed view of the first reinforcement member 313, the liquid permeable barrier 315, and the second reinforcement member 317 prior to the initiation phase 341 illustrates the relative disposition of each component. Preferably, the liquid permeable barrier 315 is approximately the same width as the first reinforcement member 313; however, the liquid permeable barrier 315 could be narrower than or wider than the first reinforcement member. An advantage is provided by providing a liquid permeable barrier 315 that is of equal width or wider than the first reinforcement member 313 since the liquid permeable barrier 315 would provide complete protection across the entire width of the soil brace 311 after the second reinforcement member 317 is folded around the first reinforcement member 313. If a liquid permeable barrier 315 of lesser width is used, it is preferred that multiple pieces of the liquid permeable barrier 315 be used to provide complete protection across the width of the soil brace 311. FIG. 6 also illustrates the preferred material choice of a plastic or metal mesh for the first and second reinforcement members 313, 317.

Referring to FIG. 7, the initiation phase 341 involves the application of an initiation force to the extension region 333 on each side of the second reinforcement member 317. The initiation force is applied by a press member 353 in a direction indicated by reference arrow 351. The initiation force bends the extension region 333 of the second reinforcement member 317 to create a wing 355 (see FIG. 8). A platen 357 is held against the first reinforcement member 313 to secure the first reinforcement member 313, the liquid permeable barrier 315, and a central portion of the second reinforcement member 317 against the conveyor system 331 as the initiation force is applied. The press member 353 and the platen 357 may be hydraulically, pneumatically, mechanically, or manually actuated. Of course, the platen 357 could also be a static part under which the components of the soil brace 311 travel. In this regard, the platen 357 could be formed from a substantially flat plate, or a series of rollers could be used as platens in the initiation phase 341.

Referring to FIG. 8, the intermediate phase 347 involves the application of an inward force to the wings 355 created during the initiation phase 341. The inward force is applied by a press member 361 in a direction indicated by reference arrow 365. The inward force bends the wings 355 of the second reinforcement member 317 toward one another, and preferably, following the application of the inward force, each wing 355 remains biased toward the other. A platen 371 is preferably held against the first reinforcement member 313 to secure the first reinforcement member 313, the liquid permeable barrier 315, and the second reinforcement member 317 against the conveyor system 331 as the inward force is applied. Further stabilization of the second reinforcement member 313 is inherent during the application of the inward force since the inward force exerted on one of the wings 355 is equal and opposite to the inward force exerted on the other of the wings 355. The press member 361 and the platen 371 may be hydraulically, pneumatically, mechanically, or manually actuated. Of course, the platen 371 could also be a static part under which the components of the soil brace 311 travel. In this regard, the platen 371 could be formed from a substantially flat plate, or a series of rollers could be used as platens in the intermediate phase 347. As mentioned previously, the intermediate phase 347 could be an optional phase. In lieu of the intermediate phase 347, an initiation phase 341 that combines the application of the initiation force and the inward force may be performed. In such a case, the application of force would likely be performed in a single rotational motion, such as by utilizing a hinged press member (not shown) that rotates against the extension region 333 of the second reinforcement member 317, thereby exerting the initiation force and the inward force required to create the wing 355 and bias each wing 355 toward the other.

Referring to FIG. 9, the crimping phase 345 involves the application of a crimping force to the wings 355 created during the initiation phase 341 and intermediate phase 347. The crimping force is preferably applied by a press member 381 in a direction indicated by reference arrow 385. The press member 381 exerts the crimping force on the wing 355 in a direction toward the conveyor system 331. The crimping force directs the wing 355 into a position that is adjacent to a portion of the first reinforcement member 313 and substantially parallel to that portion of the second reinforcement member 317 that was between the extension regions 333. In addition to or in lieu of the crimping force provided by the press member 381, the crimping force may also be provided by a crimping roller (not shown) positioned downstream of the initiation phase 341 or the intermediate phase 347. The press member 381 may be hydraulically, pneumatically, mechanically, or manually actuated.

After exiting the crimping phase 345 and passing under the optional crimping roller, the first reinforcement member 313, the liquid permeable barrier 315, and the second reinforcement member 317 are interlocked such that the second reinforcement member 317 cradles the first reinforcement member 313 and the liquid permeable barrier 315. The wings 355 of the second reinforcement member 317 have been folded around the edges of the first reinforcement member 313 to securely retain the three components of the soil brace 311 together.

Referring to FIG. 10, a method 411 of manufacturing a gardening and construction apparatus according to the principles of the present invention is illustrated. The method 411 includes at step 413 positioning a liquid permeable barrier between a first reinforcement member and a second reinforcement member. At step 415, the relative positions of the first and second reinforcement members are maintained by folding the second reinforcement member around at least a portion of the first reinforcement member.

While the manufacturing processes illustrated in FIGS. 4, 5, and 10 involve a conveyor system positioned beneath the components of the soil brace, the process could be performed using similar techniques with any orientation of the conveyor system and the soil brace components. For example, the components could be hung beneath a conveyor system and passed through a tunnel or other process that exerts an initiation force oriented in a downward direction. The initiation force in this instance would form wings that would then be folded around the liquid permeable barrier and the first reinforcement member, both of which may be located underneath the second reinforcement member. Another alternative orientation of the manufacturing process could include a vertically oriented conveyor system that would take advantage of gravity to feed the soil brace components in the direction of production.

The manufacturing processes described in reference to FIGS. 4-10 all involve folding or bending the second reinforcement member around the first reinforcement member. As used herein in relation to folding or bending the second reinforcement member around the first reinforcement member, the terms “fold” or “bend” describe the act of moving or deforming the second reinforcement member relative to the first reinforcement member such that the relative positions of the first and second reinforcement members are maintained. Maintenance of the relative positions of the first and second reinforcement members does not require that all movement of the first reinforcement member be fixed relative to the second reinforcement member. Rather, maintenance of the relative positions simply requires that movement of the first reinforcement member relative to the second reinforcement member be constrained enough to retain the liquid permeable barrier between the reinforcement members and prevent an inadvertent disengagement of the reinforcement members.

It should be apparent from the foregoing that an invention having significant advantages has been provided. While the invention is shown in only a few of its forms, it is not just limited but is susceptible to various changes and modifications without departing from the spirit thereof.

We claim:

1. A method of manufacturing a gardening and construction apparatus comprising the steps of:
positioning a liquid permeable barrier between a first reinforcement member and a second reinforcement member, the second reinforcement member being wider than the first reinforcement member to create at least one extension region extending beyond an edge of the first reinforcement member; and
maintaining relative positions of the first and second reinforcement members by folding the at least one extension region of the second reinforcement member around a portion of the first reinforcement member.

2. The method according to claim 1, wherein the at least one extension region is a pair of extension regions and the pair of extension regions extend beyond opposing edges of the first reinforcement member.

3. The method according to claim 2, wherein the step of securing the first reinforcement member to the second reinforcement member by folding further comprises:
exerting an initiation force on pair of extension regions to form a pair of wings that cradle the first reinforcement member and the second reinforcement member;
exerting a crimping force on the wings to move the wings toward the first reinforcement member.

4. The method according to claim 3, further comprising:
prior to exerting the crimping force, exerting an inward force on each wing to inwardly bias the wings toward one another.

5. The method according to claim 4, wherein the first reinforcement member, the second reinforcement member, and the liquid permeable barrier, are pre-cut to substantially equal lengths.

6. The method according to claim 4, wherein the steps of exerting an initiation force, exerting an inward force, and exerting a crimping force are performed in separate stages as the first reinforcement member, the second reinforcement member, and the liquid permeable barrier are processed on a conveyor belt.

7. The method according to claim 3, wherein the first reinforcement member and the liquid permeable barrier are centrally positioned on the second reinforcement member prior to exerting the initiation force such that the width of the extension regions is substantially equal.

8. The method according to claim 2, wherein the step of securing the first reinforcement member to the second reinforcement member by folding further comprises:
advancing the first reinforcement member, the second reinforcement member, and the liquid permeable barrier in a direction of production; and
sequentially exerting to the at least one extension region an initiation force, an inward force, and a crimping force.

9. The method according to claim 8, wherein the exertion of the initiation force, the inward force, and the crimping force is such that at least two of the forces may be applied to the extension regions simultaneously.

10. The method according to claim 8 further comprising:
continuously feeding the first reinforcement member, the second reinforcement member, and the liquid permeable barrier from separate rolls of material.

11. The method according to claim 8 further comprising:
centering the first reinforcement member and the liquid permeable barrier on the second reinforcement member such that the width of the extension regions is substantially equal.

12. The method according to claim 2, wherein the step of securing the first reinforcement member to the second reinforcement member by folding further comprises:
advancing the first reinforcement member, the second reinforcement member, and the liquid permeable barrier in a direction of production;
exerting a rolling force on the extension regions to fold the extension regions over portions of the first reinforcement member; and
exerting a crimping force on the folded extension region to further secure the second reinforcement member to the first reinforcement member.

13. The method according to claim 12, wherein the crimping force is at least partially exerted by a roller.

14. The method according to claim 12, wherein the rolling force on each extension region is exerted by a tunnel positioned to contact the extension region and exert both initiation and inward forces to the extension region.

15. The method according to claim 14, wherein the crimping force is at least partially exerted by the tunnel.

16. The method according to claim 12 further comprising:
continuously feeding the first reinforcement member, the second reinforcement member, and the liquid permeable barrier from separate rolls of material.

17. The method according to claim 12 further comprising:
centering the first reinforcement member and the liquid permeable barrier on the second reinforcement member such that the width of the extension regions is substantially equal.

18. A gardening and construction apparatus comprising:
a first reinforcement member having a first edge and a second edge; and
a second reinforcement member having a central support portion and a pair of wings, the wings being disposed on opposing longitudinal sides of the central support portion and being folded around the first and second edges of the first reinforcement member to secure the second reinforcement member to the first reinforcement member; and
a liquid permeable barrier disposed between the first reinforcement member and the second reinforcement member.

19. The gardening and construction apparatus according to claim 18, wherein the wings of the second reinforcement member are of substantially equal width.

20. The gardening and construction apparatus according to claim 18, wherein the first and second reinforcement members each comprise a metal or plastic grid.
